(19) United States
(12) Patent Application Publication
(10) Pub. No.: US 2009/0063895 A1
(43) Pub. Date: Mar. 5, 2009

(54) SCALEABLE AND MAINTAINABLE SOLID STATE DRIVE

(76) Inventor: Kurt Smith, Boise, ID (US)

Correspondence Address: LEFFERT JAY & POLGLAZE, P.A., P.O. BOX 581009, MINNEAPOLIS, MN, 55458-1009, US

(21) Appl. No.: 11/849,644

(22) Filed: Sep. 4, 2007

(51) Int. Cl. G06F 11/16; G06F 12/02

(52) U.S. Cl. 714/7; 711/E12.008

(57) ABSTRACT

Methods and apparatus for maintaining a solid state disk drive facilitate expansion of storage capacity and maintenance of internal memory storage media, for example, are disclosed. Memory modules are adapted for removable installation in a solid state drive allowing for expansion of drive storage capacity and servicing of failed or worn out memory storage media. Data can be managed to mitigate loss during expansion, maintenance and servicing of the solid state drive.

### TECHNICAL FIELD OF THE INVENTION

The present invention relates generally to memory devices. In particular, embodiments of the present disclosure relate to managing and maintaining solid state data storage drives.

### DESCRIPTION OF THE RELATED ART

Bulk memory storage devices are utilized by many types of electronic devices. A common example of a bulk memory storage device is a hard disk drive (HDD). HDDs are capable of large amounts of storage at relatively low cost, with current consumer HDDs available with over one terabyte of capacity.

HDDs generally store data on rotating magnetic media or platters. Data is typically stored as a pattern of magnetic flux reversals on the platters. To write data to a typical HDD, the platter is rotated at high speed while a write head floating above the platter generates a series of magnetic pulses to align magnetic particles on the platter to represent the data. To read data from a typical HDD, resistance changes are induced in a magnetoresistive read head as it floats above the platter rotated at high speed. In practice, the resulting data signal is an analog signal whose peaks and valleys are the result of the magnetic flux reversals of the data pattern. Digital signal processing techniques called partial response maximum likelihood (PRML) are then used to sample the analog data signal to determine the likely data pattern responsible for generating the data signal.

HDDs have certain drawbacks due to the mechanical nature of their construction. HDDs are susceptible to damage or excessive read/write errors due to shock, vibration or strong magnetic fields. In addition, they are relatively large users of power in portable electronic devices.

Another example of a bulk storage device is a solid state drive (SSD). Instead of storing data on rotating media, SSDs utilize semiconductor memory devices to store their data and include an interface and form factor making them appear to their host system as if they are a typical HDD. The memory devices of SSDs are typically non-volatile flash memory devices. Non-volatile memory devices are those devices that retain data even after power has been removed from the device.

Flash memory devices have developed into a popular source of non-volatile memory for a wide range of electronic applications. Flash memory devices typically use a one-transistor memory cell that allows for high memory densities, high reliability, and low power consumption. Changes in threshold voltage of the cells, through programming of charge storage or trapping layers or other physical phenomena, determine the data value of each cell. Common uses for flash memory and other non-volatile memory include personal computers, personal digital assistants (PDAs), digital cameras, digital media players, digital recorders, electronic games, appliances, vehicles, wireless device and mobile telephones.

Unlike HDDs, SSDs are generally not susceptible to the effects of vibration, shock or magnetic fields due to their solid state nature. Similarly, without moving parts, SSDs typically have lower power requirements than HDDs. However, SSDs currently have much lower storage capacities compared to HDDs of the same form factor and a significantly higher cost per bit. Similar to HDDs, SSDs are also not user friendly to repair should a failure occur of one of the internal memory storage devices, and they are of fixed storage capacity.

For the reasons stated above, and for other reasons which will become apparent to those skilled in the art upon reading and understanding the present specification, there is a need in the art for alternate solid state drives.

### BRIEF DESCRIPTION OF THE DRAWINGS

FIG. 1 is a functional block diagram of an electronic system having at least one SSD memory device according to one embodiment of the present disclosure

FIG. 2 is a figure of a solid state drive according to one embodiment of the disclosure.

FIG. 3 is a figure of a memory module according to one embodiment of the disclosure.

FIG. 4 is a flowchart for replacing a memory module according to one embodiment of the disclosure.

FIG. 5 is a flowchart for transferring data between two memory modules according to one embodiment of the disclosure.

### DETAILED DESCRIPTION

In the following detailed description of the present embodiments, reference is made to the accompanying drawing that form a part hereof, and in which is shown by way of illustration specific embodiments in which the embodiments may be practiced. These embodiments are described in sufficient detail to enable those skilled in the art to practice the invention, and it is to be understood that other embodiments may be utilized and that process, electrical or mechanical changes may be made without departing from the scope of the present disclosure. The following detailed description is, therefore, not to be taken in a limiting sense.

Currently available SSDs are often configured and constructed to be a drop in replacement for an existing HDD. For example, an SSD could be configured to be a drop in replacement for a 2.5″ HDD commonly used in laptop computers. The lack of moving parts and lower power requirements make SSDs well suited for portable electronic devices which often run on batteries. SSDs are also well suited for devices which require high reliability but also may experience rough handling or hostile operating environments due to vibration, shock, strong magnetic fields, etc.

Currently available SSDs share some characteristics with their HDD counterparts. SSDs and HDDs are not user friendly or cost effective to repair should a failure occur inside the drive. Replacing the defective storage media in a HDD would require disassembly of the drive and replacing the hard disk itself. As the memory storage devices of an SSD tend to be soldered to printed circuit boards, replacing a defective memory storage device in an SSD would require disassembly of the drive to remove the internal circuit card to which the memory storage devices have been soldered. The failed memory storage devices would then need to be identified and de-soldered from the circuit card assembly followed up with soldering of replacement memory storage devices to the circuit card assembly. The memory storage devices used in SSDs are typically surface mount integrated circuits with high pin counts and fine pitch leads. This type of circuit card assembly re-work makes the replacement of individual memory storage devices in currently available SSDs impractical and generally cost prohibitive. Instead, the failed SSD would likely be discarded and a replacement SSD would be installed in the system.

Another characteristic shared by SSDs and HDDs is that the storage capacity of the drive cannot practically be expanded. Expanding the storage capacity would require replacement of the hard disk itself and associated support circuitry in a HDD. SSDs typically contain a printed circuit card with a fixed number of memory devices resulting in a SSD whose storage capacity also cannot be expanded. Thus, if an increase in storage capacity is needed, a higher capacity replacement SSD or additional SSDs need to be purchased and installed in the system. Again, these scenarios would likely result in the existing HDD or SSD being discarded and replaced with a higher capacity drive if more storage capacity was needed or desired. Having to add additional drives can also pose an implementation problem because many electronic systems are limited in the number of drives (HDD or SSD) that can be utilized by the system

One or more embodiments of the present disclosure negate having to discard a SSD due to an internal failure of a memory device or a need to expand the storage capacity of the drive. As disposal of discarded electronics is a problem that continues to grow, the embodiments of the present disclosure provide benefits of cost savings and in reduced environmental impact due to a reduction in the amount of hardware requiring disposal.

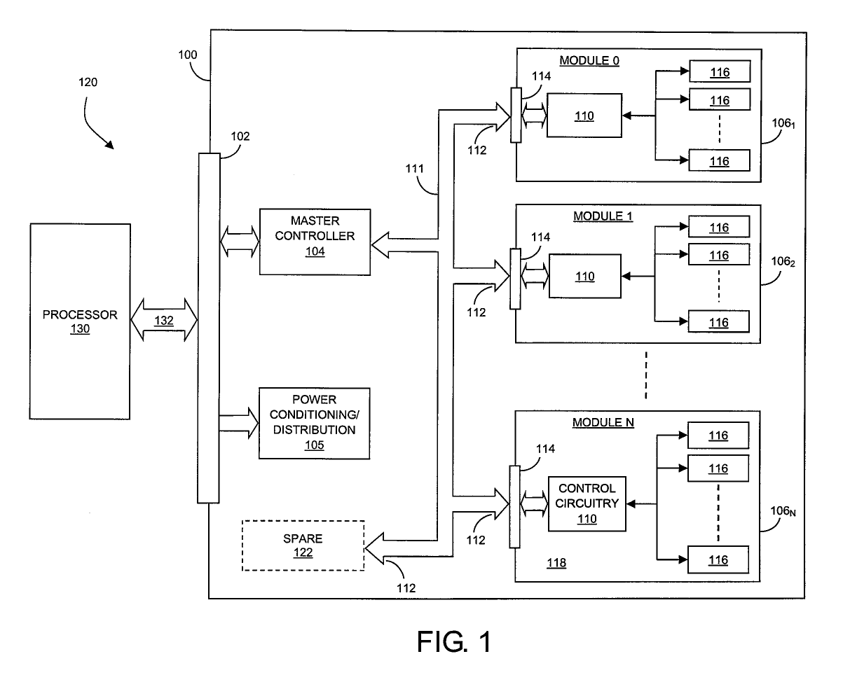

FIG. 1 is a block diagram of a scaleable SSD memory device 100 in communication with (e.g., coupled to) a processor 130 as part of an electronic system 120, according to one embodiment of the present disclosure. Some examples of electronic systems include personal computers, laptop computers, personal digital assistants (PDAs), digital cameras, digital media players, digital recorders, electronic games and the like. The processor 130 may be a disk drive controller or other external processor. Typically there exists a standard bus 132 employing a standard protocol that is used to connect the processor 130 and the SSD memory device 100. The bus typically consists of multiple signals including address, data, power and various I/O signals. The type of interface bus 132 will depend on the type of drive interface being utilized in the system 120. Examples of some conventional disk drive interface bus protocols are IDE, ATA, SATA, PATA, Fibre Channel and SCSI. Other drive interfaces exist and are known in the art. It should be noted that FIG. 1 has been simplified to focus on the embodiments of the present disclosure. Additional or different components, connections and I/O signals could be implemented as are known in the art without departing from the scope of the present disclosure.

The storage capacity of the SSD 100 illustrated in FIG. 1 is highly configurable. For example, SSDs according to various embodiments of the present disclosure may be configured as having 16, 32 or 64 GB of capacity by removably coupling 1, 2 or 4 GB memory modules into the SSD. Other SSD capacities can be achieved by utilizing various storage capacity memory modules without deviating from the scope of the embodiments of the present disclosure.

The SSD memory device 100 according to one embodiment of the present disclosure as illustrated in FIG. 1 includes an interface 102 to allow a processor 130, e.g., a drive controller, to interact with the SSD memory device 100 over a standard hard drive bus interface 132. The interface 102 may consist of a single connector or multiple connectors. For instance, the interface 102 may have one connector for power and another connector for I/O signals such as data, address and control signals. The interface connector 102 may be one of many standardized connectors commonly known to those skilled in the art. Some examples of these interface 102 connectors are IDE, ATA, SATA and PCMCIA connectors. As various embodiments of the present disclosure can be configured to emulate a variety of conventional type HDDs, other standardized disk drive connectors may also be utilized at the interface 102.

The SSD 100 according to one embodiment of the present disclosure as illustrated in FIG. 1 also includes a master controller 104, power conditioning/distribution circuitry 105 and a number of memory modules 106₁-106_{N}. Some of the functions performed by the master controller 104 are to manage operations within the SSD and communicate with devices external to the SSD such as the processor 130 over the interface 132. The power conditioning/distribution circuitry 105 distributes power to the various circuitry inside the SSD 100. The power conditioning/distribution circuitry may also regulate the power supplied to the SSD 100 to provide various voltages required by the SSD 100 internal circuits including the memory modules 106₁-106_{N}. Memory modules 106₁-106_{N} act as the bulk storage media for the SSD 100.

The master controller 104 manages the various operations of the SSD 100. As discussed, an SSD may be used as a drop in replacement for a standard HDD and there exist many standardized HDDs which have standard interfaces and communication protocols. Thus, one of the many functions of the master controller 104 is to emulate the operation of one of these standardized HDD protocols. Another function of the master controller 104 is to manage the operation of the memory modules installed in the SSD 100. The master controller 104 can be configured to communicate with the memory modules 106₁-106_{N} using a variety of standard communication protocols 111. For example, in one embodiment of the present disclosure, the master controller 104 interacts 111 with the memory modules 106₁-106_{N} using a SATA protocol. Other embodiments may utilize other communication protocols to communicate 111 with the memory modules. Communication 111 between the master controller 104 and the memory modules 106₁-106_{N} may be implemented by utilizing a common bus and/or discrete connections. The master controller 104 may also perform additional functions relating to the memory modules such as ECC checking and ChipKill operations. Implementation of the master controller 104 may be accomplished by using hardware or a hardware/software combination, for example, the master controller 104 may be implemented in whole or in part by a state machine.

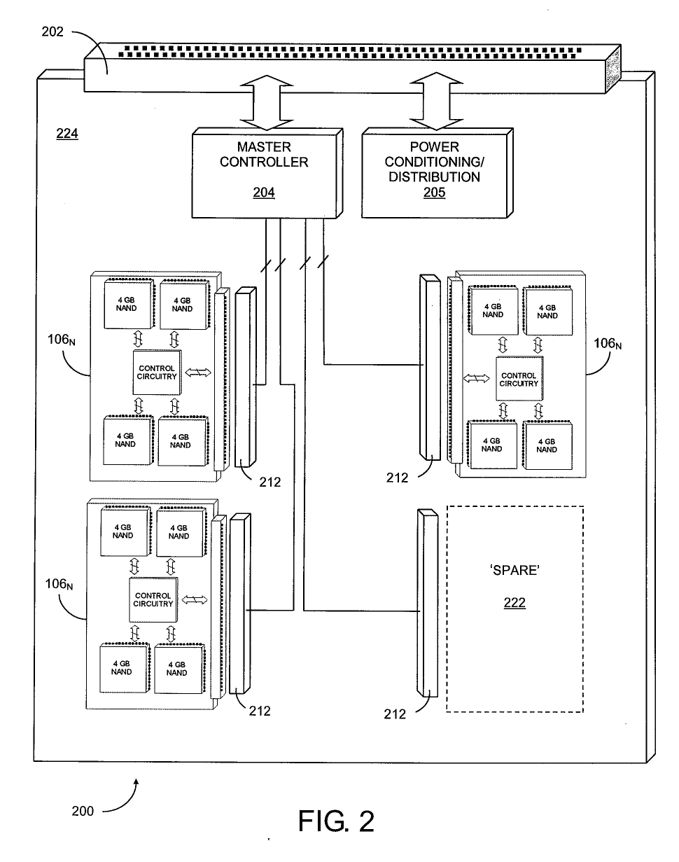

Memory modules are coupled to the master controller at the locations indicated by the block arrows 112 shown in FIG. 1. These master controller memory module coupling locations 112 in one embodiment of the present disclosure can be an electrical connector of a mechanical nature as are known to those skilled in the art. The coupling locations 112 may consist of a single connector or multiple (e.g. independent) connectors. Examples of connectors are DIP, SIPP, SIMM, DIMM, SO-DIMM and Butterfly connectors in either male (plug) or female (receptacle) form. Other connectors that allow for interfacing with the signals of a memory module 106₁-106_{N} could also be used. FIG. 2 illustrates one embodiment of the present disclosure having the master controller circuitry 104/204 and master controller module coupling locations 112/212 arranged on a single printed circuit board (PCB) 224 inside the SSD 100/200. The coupling locations 112/212 could be arranged as a row of connectors (e.g. sockets) allowing for the efficient and orderly installation of multiple memory modules 106₁-106_{N} in the SSD 100/200. Other physical layouts, configurations and number of coupling locations 112/212 could be utilized without departing from the scope of the present disclosure.

Spare (e.g. unoccupied) coupling locations 122/222 may also be present to allow for expansion or data handling operations of the SSD 100. These spare locations 122/222 may be an open coupling location where a memory module has not been installed. In alternate embodiments, the spare location could have a memory module installed for the purposes of redundancy or as a temporary storage area. Multiple configurations and numbers of spare locations may exist in the SSD according to various embodiments of the present disclosure.

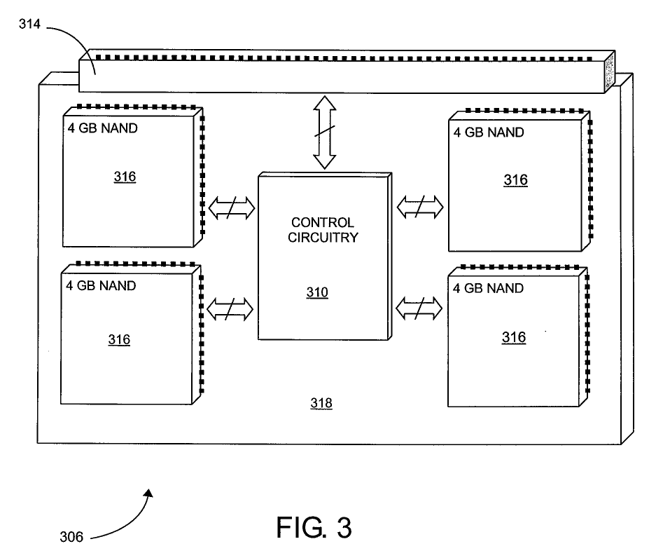

The SSD 100 illustrated in FIG. 1 is further comprised of one or more memory modules 106₁-106_{N}. These memory modules are labeled “Module 0”-“Module N” in FIG. 1. The number of memory modules 106₁-106_{N} can range from 1 to N memory modules. The memory modules 106₁-106_{N} act as the bulk storage media for the SSD. In one embodiment of the present disclosure which is illustrated in FIG. 3, each memory module 306 contains a PCB 118/318, one or more memory storage devices 116/316, control circuitry 110/310 and an electrical interface 114/314. The one or more memory storage devices 116/316 of the memory modules 106₁-106_{N} may be flash memory devices and take the form of surface mount integrated circuits mounted on the PCB 118/318. For example, as illustrated in FIG. 3, the memory storage devices 316 are 4 GB NAND flash memory devices. Other types, packaging methods and capacities of memory can be utilized as is known to those skilled in the art. Examples include memory such as NAND and NOR type flash memory.

Memory modules 106₁-106_{N} can also be tested prior to installation in the SSD. In addition, the same memory modules may be utilized by the SSD regardless of the external interface being used by the processor 130. For example, one SSD might be configured to use a PATA interface with a processor 130. Another SSD might be configured to communicate with a processor 130 over a SATA interface. In both cases, the same memory modules 106₁-106_{N} can be utilized by the two drives. This can have the effect of reducing costs because memory modules do not have to be dedicated to one type of SSD interface.

Again referencing FIG. 1, the control circuitry 110 manages the operation of the memory storage devices 116 on the memory modules 106₁-106_{N}. The control circuitry 110 may also act to translate the communication protocol utilized by the master controller 104 to communicate with the memory module 106₁-106_{N}. For example, in one embodiment of the present disclosure, the master controller 104 may be utilizing an SATA protocol to interact with the memory modules 106₁-106_{N}. In such an embodiment, the control circuitry 110 is configured to emulate a SATA interface. The control circuitry 110 can also manage other memory functions such as security features to regulate access to data stored in the memory module. The control circuitry 110 may also utilize various types of volatile and non-volatile memory for the purpose of storing information specific to the memory module such as serial number, wear leveling status, failure rates, etc. Control circuitry 110 may also utilize volatile memory such as DRAM to be used as a high speed cache to improve performance of the module. Implementation of the control circuitry 110 may be by discrete logic, memory controller or state machine. Other implementations are known to those skilled in the art.

In embodiments utilizing flash memory devices 116 in the memory modules 106₁-106_{N}, the control circuitry 110 may also be configured to perform maintenance of the flash memory storage devices 116 or flash servicing operations. Such maintenance and servicing tasks may include repairing and tracking of repair rates of the flash memory devices 116 to determine if the flash memory devices are ‘worn out’ and are nearing the end of their useful life. Wear leveling operations may also be performed by the control circuitry 110. The control circuitry 110 can also monitor for hard failures occurring in the memory devices 116. The control circuitry 110 can be further configured to provide information on its respective memory module to the master controller 104 such as the need to replace a memory module.

The configurations of the master controller/memory module interface, formed upon coupling a memory module electrical interface 114 to a master controller memory module coupling location 112, can provide for a highly configurable and maintainable SSD along with the additional benefits of reduced costs and reduced waste. The master controller/memory module interface of the various embodiments of the present disclosure can utilize a method of removably coupling one or more memory modules 106₁-106_{N} to the master controller 104. This is in contrast to permanently coupling and configuring memory devices as is done in currently available SSDs. Various embodiments allow for multiple configurations of the master controller and memory modules. For example, in one embodiment according to the present disclosure, both the master controller memory module coupling location 112 and the memory module electrical interface 114 are comprised of a mechanical connector which allows for the reliable yet temporary coupling of the memory module 106₁-106_{N} signals to the signals of the master controller 104. Due to the importance of signal integrity in memory storage devices, any coupling of signals whether permanent or temporary should be reliable to prevent any corruption of data. Mechanical connectors utilize various techniques to provide temporary and reliable connections. These techniques rely on the compression of one electrical conductor into contact with a second electrical conductor to effectuate an electrical connection at the point of contact. As discussed previously, these electrical connectors located at the interface locations 112/114/314 may be of a variety of standardized types and configurations as are known in the art. Examples include, but are not limited to, DIP, SIPP, SIMM, DIMM, SO-DIMM, Butterfly, IDE, ATA and SATA connectors in plug and receptacle form. Other connectors that allow for a temporary and reliable coupling of signals between the master controller 104 and a memory module 106_{N}/306 are known to those skilled in the art.

In an alternate embodiment according to the present disclosure, only one of the master controller memory module coupling location 112 and memory module electrical interface 114 is comprised of a mechanical connector. For example, in this embodiment, the means of coupling the master controller 104 and a memory module 106₁-106_{N} is accomplished by what is known in the art as a PCB edge type connector. In this embodiment, the master controller memory module coupling location 112 or the memory module electrical interface 114 may be comprised of a mechanical connector. The other portion, 112 or 114, would consist of a row or some other arrangement of electrical contacts or pads on a PCB or other suitable structure which is capable of being mechanically and electrically coupled with the mechanical connector. This embodiment also allows for a reliable yet temporary coupling of the master controller 104 and a memory module 106₁-106_{N}. The master controller 104 may also be configured to perform data management within the SSD 100. For example, should the control circuitry 110 of a memory module 106₁-106_{N} indicate to the master controller 104 that the memory module is nearing the end of its useful life, the master controller 104 can then perform an operation to transfer the data stored in the ‘worn out’ memory module to a different module in the SSD before a hard failure occurs. The data may be transferred to an already existing memory module of the SSD or an additional memory module may be installed in a ‘spare’ location 122 of the SSD to receive the transferred data from the worn out memory module. The master controller 104 can also provide an indication that the worn out memory module should be replaced with a replacement memory module. This indication can occur at the SSD level (e.g. an LED or other status indicator located on the SSD) or consist of a signal transmitted to the processor or controller 130 utilizing the SSD. The controller or processor 130 would utilize a software application that handles signals from the master controller 104 signaling that a memory module is in need of replacing or nearing the end of its useful life, etc. This functionality is similar to Self-Monitoring, Analysis and Reporting Technology (SMART) used in relation to traditional HDDs. SMART is well known to those skilled in the art.

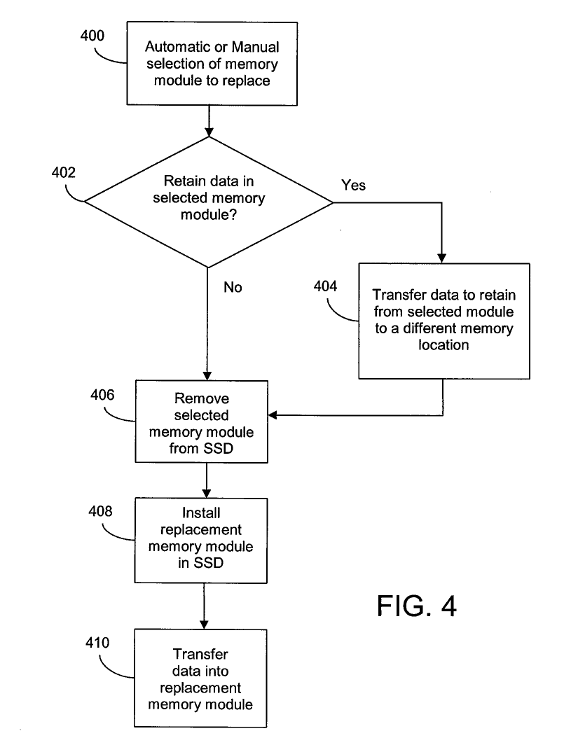

The transfer of data from a memory module selected for replacement may occur automatically or be initiated manually. FIG. 4 illustrates both an automatic and manual transfer of data from a memory module selected to be replaced in the SSD.

In one embodiment of the present disclosure, a data transfer between memory modules may be performed automatically 400 by the master controller 104 in response to some condition (e.g. a predetermined condition) being met. For example, the control circuit 110 of a memory module 106₁-106_{N} may indicate to the master controller 104 that a hard failure has occurred or that the memory module is nearing the end of its useful life. In this embodiment, the master controller 104 may automatically perform a data transfer 404 from the failed or worn out memory module to another memory module in the SSD 100. The master controller 104 may then provide some indication to the processor or controller 130 that a data transfer has occurred and that the failed or worn out memory module is no longer in use and should be replaced. At this point the memory module selected to be replaced can be removed from the SSD 406 and a replacement memory module can be installed 408. After installation of the replacement memory module the retained data may or may not be transferred back into the replacement module 410.

In an alternate embodiment, the data transfer may be performed on a manual basis. For example, if a memory module currently in use is going to be replaced with a higher capacity memory module, the user or processor 130 may provide a command 402 for the SSD 100 to transfer data from the memory module selected to be removed 400 to a memory module that is not being removed 404 from the drive so as not to loose any stored data as a result of the memory capacity upgrade. Different embodiments allow for the manual data move to be completely managed by the user (e.g. the user can directly select where the data to be moved will reside in the SSD.) Alternatively, the manual data transfer operation may consist of the user indicating which memory module will be replaced and the master controller 104 would determine the new location(s) of the data being moved based upon available capacity. After the data has been transferred the memory module selected to be removed is removed from the drive 406 and the replacement memory module is installed in the SSD 408. The replacement memory module may or may not be installed in the same location 112 as the memory module selected for removal. (e.g., the replacement memory module may be installed in a ‘spare’ location 122 in the SSD.) After the replacement memory module is installed, the retained data may or may not be transferred back into the replacement module.

As discussed, memory modules 106₁-106_{N} can be replaced with a replacement memory module of a different storage capacity than the module being removed. For example, if an increase in memory storage capacity is desired, an existing memory module could be replaced with a higher capacity module or an additional module could be added to an unoccupied or ‘spare’ location 122 in the SSD. This allows for a cost effective means of incrementally increasing the storage capacity of the SSD. Similarly, the storage capacity of the SSD could be reduced by removing memory modules or replacing existing modules with lower capacity memory modules. Changing the storage capacity of the SSD could be done at any time. For example, changing the storage capacity of the SSD would not be dependent upon the occurrence of a failure or a memory module ‘end of life’ indication. In addition, various embodiments of the present disclosure allow for the possibility of ‘hot swapping’ memory modules. Hot swapping would not be recommended with current SSDs utilizing permanently installed memory devices as this would likely result in short circuits and potentially cause serious damage to the SSD. Hot swapping, according to one or more embodiments of the present disclosure, also allows for maintenance to be performed on the SSD without taking the system 120 or the SSD 100 offline.

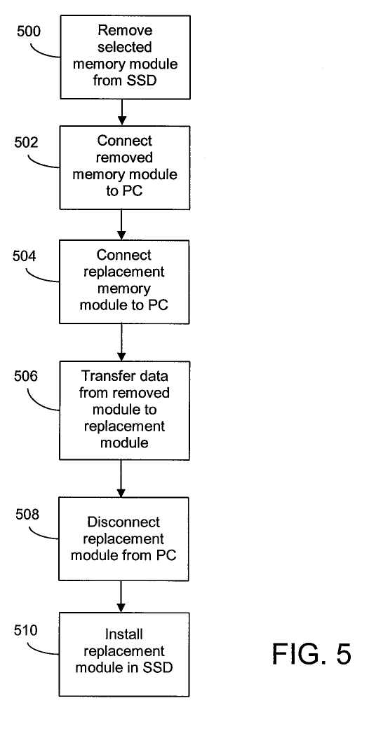

Alternate embodiments of the present disclosure allow for the removal of memory modules currently storing data such as for increasing the capacity of the SSD. Prior to removing a memory module with the SSD operating, a command may be sent to the master controller 104 of the SSD 100 to ensure that the master controller does not try to utilize a memory module 106₁-106_{N} that is in the process of being replaced. A means for coupling a memory module removed from the SSD and still containing data with a replacement memory module is then employed to transfer the stored data into the replacement memory module prior to installing it in the SSD. This procedure according to one embodiment is illustrated in FIG. 5. The method of achieving this data transfer is performed by using a personal computer (PC) or other similar computing device. The removed memory module 500 would be connected to the PC 502 such as through an interface cable configured to couple with the electrical interface 114 on the memory module 106₁-106_{N}. This memory module would act as the source memory module for the data transfer. The replacement memory module would also be coupled to the PC 504 through the same means as the source memory module and would act as the target module for the data transfer. Other methods of coupling the source and target memory modules could be utilized as are known to those skilled in the art. The PC, running software to facilitate the data transfer from the source memory module to the target memory module, performs the transfer of data 506. The data transfer application may also perform a read back of the data stored in the target memory module to verify that there were no errors that occurred during the transfer of data from the source to the target memory module. The target memory module (e.g., the replacement module) is then disconnected from the PC 508 and is installed in the SSD 100/510. Thus, the memory capacity of the SSD 100 has been increased without loss of data. At this point, the user can provide some form of input that indicates that the replacement module can now be used by the SSD 100. In alternate embodiments, the master controller 104 may periodically poll the coupling locations 112 to automatically determine if a memory module is installed and is available for use by the SSD. Therefore, embodiments of the present disclosure allow for servicing and modification of the SSD without interruption of a system utilizing the SSD (e.g., hot swapping memory modules.)

Additional memory modules 106₁-106_{N} and controllers 104 can be added to the SSD to allow for operating the SSD in a RAID 0 or RAID 1 data storage scheme. Bandwidth can be increased through the use of a RAID 0 (‘striping’) configuration. A RAID 1 (‘mirror’) configuration would allow for 100% redundancy, thus protecting data from loss. Both RAID 0 and RAID 1 configurations and schemes are well known to those skilled in the art.

### CONCLUSION

Various embodiments of the present disclosure provide methods for maintaining and modifying a scaleable solid state drive and apparatus configured to perform these methods. For one embodiment, the scaleable and maintainable solid state drive comprises multiple locations for temporarily installing memory modules. These modules may be installed or removed in order to maintain, service and modify the storage capacity of the solid state drive. Methods for maintaining, servicing and modifying the solid state drive are also disclosed.

Although specific embodiments have been illustrated and described herein, it will be appreciated by those of ordinary skill in the art that any method or apparatus that is calculated to achieve the same purpose may be substituted for the specific embodiments shown. Many adaptations of the disclosure will be apparent to those of ordinary skill in the art. Accordingly, this application is intended to cover any adaptations or variations of the various embodiments.

1. A scaleable drive device, comprising:
a master controller for managing operation of the drive device; and
a plurality of coupling locations for removably coupling memory modules to the master controller.

2. (canceled)

3. The drive device of claim 1 further comprising an interface to receive and transmit signals relating to the operation of the drive device.

4. The drive device of claim 3 wherein the master controller is configured to manage the operation of the drive device in response to the received signals.

5. The drive device of claim 1 further comprising one or more memory modules removably coupled to the coupling locations, wherein the memory modules each comprise a memory module electrical interface adapted to mate with a coupling location.

6. (canceled)

7. The drive device of claim 5 wherein at least one of the one or more memory modules comprises one or more memory storage devices and wherein the one or more memory storage devices are non-volatile memory storage devices.

8. The drive device of claim 7 wherein the one or more memory storage devices are flash memory storage devices.

9. (canceled)

10. The drive device of claim 5 wherein at least one of the coupling locations and the memory module electrical interface comprises a mechanical electrical connector adapted to allow coupling of the coupling locations and the memory module electrical interface.

11-13. (canceled)

14. The drive device of claim 10 wherein the mechanical electrical connectors are of either male or female configuration and selected from a list of electrical connectors consisting of DIP, SIPP, SIMM, DIMM and SO-DIMM type connectors.

15. (canceled)

16. The drive device of claim 1 wherein the interface is a connector selected from a list of connectors consisting of IDE, ATA, SATA, PATA, SCSI, D-type, IDC and PCMCIA type connectors.

17-20. (canceled)

21. The drive device of claim 1 wherein the master controller is configured to transfer data stored in a first memory module coupled to a first coupling location to a second memory module coupled to a second coupling location.

22. The drive device of claim 1 wherein the drive device is configured to allow hot swapping of memory modules coupled to the coupling locations.

23. A scaleable drive device, comprising:
a master controller for interpreting received signals and managing operation of the drive in response to the interpreted received signals;
one or more memory modules, the memory modules comprising:
a module interface;
control circuitry; and
one or more non-volatile memory devices; and
a plurality of coupling locations for removably coupling memory modules to the master controller.

24. The drive device of claim 23 wherein the master controller is configured to perform a data transfer operation between two or more memory modules coupled to the coupling locations.

25. The drive device of claim 24 wherein the master controller automatically performs the data transfer operation in response to a condition being met wherein the condition is selected from the group of conditions comprised of the occurrence of a hard failure in one or more of the memory modules and an indication that a memory module contains worn out memory.

26. The drive device of claim 24 wherein the data transfer operation is performed in response to a manually provided command.

27. A scaleable drive device, comprising:
a plurality of memory modules, the memory modules comprising a module interface, control circuitry and one or more memory storage devices;
a first subset of the plurality of memory modules;
a second subset of the plurality of memory modules;
a first master controller for managing the operation of the first subset of the plurality of memory modules in response to received signals;
a second master controller for managing the operation of the second subset of the plurality of memory modules in response to the received signals;
a first plurality of coupling locations for removably coupling the first subset of the plurality of memory modules to the first master controller; and
a second plurality of coupling locations for removably coupling the second subset of the plurality of memory modules to the second master controller.

28. The drive device of claim 27 wherein the drive device is configured to operate in a plurality of modes, the plurality of modes comprising a RAID 0 level mode and a RAID 1 level mode.

29. A method of modifying a drive, comprising:
removing a memory module from a mechanical coupling location of the drive; and
inserting a memory module into a mechanical coupling location of the drive;
wherein each of the mechanical coupling locations is adapted to mate with an electrical interface of the memory modules.

30. The method of claim 29 further comprising removing a memory module and replacing it with a memory module having the same memory storage capacity.

31. The method of claim 29 further comprising replacing a memory module in response to a failure detected in the memory module being replaced.

32. The method of claim 29 further comprising removing a memory module and replacing it with a memory module having a greater memory storage capacity than the removed memory module.

33. The method of claim 29 further comprising transferring data stored in a first memory module of the drive device to a second memory module of the drive device.

34. The method of claim 33 wherein transferring the data is performed prior to removing the first memory module.

35. The method of claim 29 further comprising replacing a memory module in response to exceeding a wear level threshold.

36. The method of claim 29 further comprising removing a memory module and replacing it with a memory module having a lower memory storage capacity than the removed memory module.

37. The method of claim 29 wherein the drive device is further adapted to facilitate removing and/or installing a memory module without interrupting power to the drive device.

38. An electronic system, the system comprising:
An external controller for generating data storage signals;
at least one scaleable drive, in communication with the external controller, the drive comprising:
a master controller for managing the operation of the drive in response to received signals; and
a plurality of independently removable memory modules coupled to the master controller.

39. The system of claim 38 wherein the drive is coupled to the external controller and utilizes one of a bus interface protocol taken from a list of protocols consisting of IDE, ATA, SATA, PATA, Fibre Channel, SCSI and PCMCIA type interface protocols.

40. The system of claim 38 wherein the independently removable memory modules are solid state memory modules.

41. A scaleable drive device, comprising:
a master controller for managing operation of the drive device; and
a plurality of coupling locations for removably coupling memory modules to the master controller; and
one or more memory modules, wherein each of the memory modules is removably coupled to one of the coupling locations;
wherein the master controller is adapted to monitor coupled memory modules for indications that the memory modules should be replaced, and to automatically perform a data transfer from a memory module indicating that it should be replaced to another memory module of the drive device.

42. The drive device of claim 41 wherein each memory module comprises one or more non-volatile memory storage devices.

43. The drive device of claim 41 wherein each of the memory modules comprises a mechanical electrical connector adapted to mate with the coupling locations.

44. The drive device of claim 43 wherein the memory modules and the coupling locations each comprise a mechanical electrical coupling having either a male or a female configuration and selected from a list of electrical connectors consisting of DIP, SIPP, SIMM, DIMM and SO-DIMM type connectors.

45. The drive device of claim 41 wherein the drive device further comprises an interface selected from the group consisting of IDE, ATA, SATA, PATA, SCSI, D-type, IDC and PCMCIA type connectors.

46. A method of modifying a solid state drive, comprising:
detecting a failure of a memory module of the drive;
removing the failed memory module from a mechanical coupling location of the drive; and
inserting a replacement memory module into a mechanical coupling location of the drive;
wherein each of the mechanical coupling locations is adapted to mate with an electrical interface of the memory modules.

47. The method of claim 46 further comprising wherein the failed memory module and the replacement memory module have the same memory storage capacity.

48. The method of claim 46 further comprising transferring data stored in the failed memory module of the drive to a different memory module of the drive prior to removing the failed memory module.

49. The method of claim 46 wherein the drive is further adapted to facilitate removing and/or installing a memory module without interrupting power to the drive.

50. The method of claim 46 wherein removing the failed memory module from a mechanical coupling location and inserting the replacement memory module into a mechanical coupling location occur using the same mechanical coupling location.

51. A method of modifying a solid state drive, comprising:
detecting that a memory module of the drive has indicated that it has neared the end of its useful life;
removing the memory module indicating that it has neared the end of its useful life from a mechanical coupling location of the drive; and
inserting a replacement memory module into a mechanical coupling location of the drive;
wherein each of the mechanical coupling locations is adapted to mate with an electrical interface of the memory modules.

52. The method of claim 51 further comprising wherein the memory module indicating that it has neared the end of its useful life and the replacement memory module have different memory storage capacities.

53. The method of claim 51 further comprising transferring data stored in the memory module indicating that it has neared the end of its useful life to a different memory module of the drive prior to inserting the replacement memory module.

54. The method of claim 51 wherein inserting the replacement module occurs in a different mechanical coupling location than the mechanical coupling location from which the memory module indicating that it has neared the end of its useful life is removed.

55. A method of modifying a solid state drive, comprising:
detecting a failure of a memory module of the drive;
removing the failed memory module from a mechanical coupling location of the drive while the drive is powered up; and
inserting a replacement memory module into a mechanical coupling location of the drive while the drive is powered up;
wherein each of the mechanical coupling locations is adapted to mate with an electrical interface of the memory modules; and
wherein the replacement memory module has a memory storage capacity that is equal to or greater than a memory storage capacity of the failed memory module.

56. The method of claim 55 further comprising inserting the replacement memory module, and transferring data stored in the failed memory module to the replacement memory module, prior to removing the failed memory module.

57. A method of modifying a solid state drive, comprising:
detecting that a memory module of the drive has indicated that it has neared the end of its useful life;
removing the memory module indicating that it has neared the end of its useful life from a mechanical coupling location of the drive while the drive is powered up; and
inserting a replacement memory module into a mechanical coupling location of the drive while the drive is powered up;
wherein each of the mechanical coupling locations is adapted to mate with an electrical interface of the memory modules; and
wherein the replacement memory module has a memory storage capacity that is equal to or greater than a memory storage capacity of the memory module indicating that it has neared the end of its useful life.

58. The method of claim 57 further comprising inserting the replacement memory module, and transferring data stored in the memory module indicating that it has neared the end of its useful life to the replacement memory module, prior to removing the memory module indicating that it has neared the end of its useful life.

59. A method of operating a solid state drive, comprising:
performing maintenance and servicing tasks for non-volatile memory devices of one or more memory modules of the drive to determine whether failure or excessive wear has occurred;
providing an indication if a failure or excessive wear is detected for any of the memory modules;
monitoring the one or more memory modules for the indications of failure or excessive wear; and
transferring data from a memory module indicating failure or excessive wear of its non-volatile memory devices to another memory module of the drive.

60. The method of claim 59 further comprising providing an indication external to the drive if a memory module has indicated failure or excessive wear of its non-volatile memory devices.

61. The method of claim 60 wherein providing an indication external to the drive comprises providing an indication using an LED or other status indicator located on the drive or providing an indication by transmitting a signal to an external processor.

62. The method of claim 60 further comprising removing the memory module indicating failure or excessive wear in response to the indication external to the drive and after transferring its data to another memory module.

63. The method of claim 62 further comprising replacing the removed memory module with a replacement memory module.

64. The method of claim 63 wherein replacing the removed memory module with a replacement memory module comprises replacing the removed memory module with a replacement memory module of the same memory capacity.

65. The method of claim 59 further comprising:
receiving a signal from an external device indicative of a desire to transfer data from a first memory module to a second memory module; and
transferring data from the first memory module to the second memory module in response to the signal.

66. A method of operating a solid state drive, comprising:
performing maintenance and servicing tasks for non-volatile memory devices of one or more memory modules of the drive to determine whether failure or excessive wear has occurred;
providing an indication if a failure or excessive wear is detected for any of the memory modules;
monitoring the one or more memory modules for the indications of failure or excessive wear; and
transferring data from a memory module to another memory module of the drive in response to either an indication of failure or excessive wear of that memory module or in response to a signal received from an external device indicative of a desire to transfer data from that memory module.

67. The method of claim 66 further comprising transmitting a second signal to the external device if a memory module has indicated failure or excessive wear of its non-volatile memory devices, wherein the second signal indicates which memory module has indicated failure or excessive wear.

68. The method of claim 67 further comprising removing the memory module indicating failure or excessive wear in response to the second signal and after transferring its data to another memory module.

69. The method of claim 68 further comprising replacing the removed memory module with a replacement memory module.

70. The method of claim 67 further comprising removing the memory module indicated by the signal received from the external device after transferring its data to another memory module.

71. The method of claim 70 further comprising replacing the removed memory module with a replacement memory module having the same or higher memory capacity.
